(19) United States
(12) Patent Application Publication
(10) Pub. No.: US 2024/0084716 A1
(43) Pub. Date: Mar. 14, 2024

(54) METHOD FOR INSPECTING A COMPONENT OF A TURBOMACHINE

(71) Applicant: MTU Aero Engines AG, Muenchen (DE)

(72) Inventors: Marius Bonhage, Hannover (DE); Nils Weidlich, Neustadt (DE); Lars Aschermann, Kalefeld-Oldenrode (DE); Frank Seidel, Grossburgwedel (DE); Philipp Döbber, Karlsfeld (DE); Dirk Wilhelm Reker, Hannover (DE)

(21) Appl. No.: 18/275,061

(22) PCT Filed: Dec. 16, 2021
(86) PCT No.: PCT/DE2021/101011

§ 371 Date: Jul. 31, 2023

(30) Foreign Application Priority Data
Feb. 2, 2021 (DE) 10 2021 200 938.7

(51) Int. Cl. F01D 21/00; G06T 7/00; G06V 10/82

(52) U.S. Cl. CPC F01D 21/003; G06T 7/0004; G06V 10/82; F05D 2260/80; F05D 2270/709; G06T 2207/10081; G06T 2207/10116; G06T 2207/20081; G06T 2207/20084; G06V 2201/10

(57) ABSTRACT

The present invention relates to a method for inspecting a component, in particular a component of a turbomachine (1), including the steps of: capturing (S2) at least one X-ray or CT image of the component (10) using an image-capturing device (20); providing (S21) metadata about the component (10), the metadata including, in particular, a component type, a running time of the component (10), a number of remaining life cycles, and/or a repair history; classifying, by a machine learning system (30), the component (10) into a “serviceable” category or a “non-serviceable” category based on the image captured by the image-capturing device (20) and the provided metadata.

### TECHNICAL FIELD

The present invention relates to a method for inspecting a component of a turbomachine and to a method for training a machine learning system.

### BACKGROUND

An axial turbomachine is functionally divided into a compressor, a combustor and a turbine. In the case of an aircraft engine, intake air is compressed in the compressor and mixed and burned with jet fuel in the downstream combustor. The resulting hot gas, a mixture of combustion gas and air, flows through the downstream turbine and is expanded therein. The turbine and the compressor are each typically made up of a plurality of stages, each including a stator and a rotor. The stators and rotors are each made up of a plurality of circumferentially arranged vanes or blades which are exposed to compressor gas or hot gas, depending on the application.

During operation of an aircraft engine or power plant turbine, components may be damaged. Examples of damage include defects, microstructural changes, or corrosion phenomena. The components disposed in the gas flow path, such as, for example, vanes, blades, or also flow path panels, are particularly prone to damage and relevant to safety. In this respect, even minor defects can be problematic because they may be a starting point for crack propagation. Therefore, the detection of such defects may be of particular importance.

It is known in the art that in the evaluation of components, such as blades or vanes, images are captured of these components, in particular X-ray images or CT images. This allows non-destructive detection of cracks or deviations in the geometry of components operating in the turbomachine, and also of pores or inadequate bonding of welds in repaired components.

### SUMMARY OF THE INVENTION

There already exist software solutions that mark probable defects based on predetermined criteria, thus assisting evaluators in their work. However, the known software solutions are not yet sufficiently reliable, so that there is always a need for manual checking.

The present invention addresses the technical problem of providing an advantageous method for inspecting a component, in particular a component of a turbomachine.

In this method, first, at least one image, in particular a light image and/or an X-ray or CT image, is captured of the component using an image-capturing device. In a further step, metadata about the component is acquired or provided, the metadata including, for example, a component type/part number, a running time of the component, a calculated remaining service life, a specified remaining service life, an operator of the turbomachine, a wall thickness, or a repair history of the component. Based on the at least one first image captured by the image-capturing device and the acquired metadata, the component being inspected is classified into either a “serviceable” category or a “non-serviceable” category by means of a machine learning system, for example, using a self-learning algorithm that is trained (for this purpose) and executed on a computer. In this context, “serviceable” mans that the component is still operational; i.e., that it could be reinstalled into a turbomachine in compliance with the approval requirements, while a component classified as “non-serviceable” is no longer operational and either needs repair or is scrap. In other words, the invention provides a method for inspecting a component using a machine learning system that includes at least one computer or similar processing device having a trained self-learning algorithm stored thereon. The machine learning system receives the at least one X-ray or CT image of the component from an image-capturing device and at least one set of metadata about the component, for example, from a database, and analyzes them using the trained self-learning algorithm.

An advantage of this is that the component can be inspected for defects, in particular cracks and/or pores, in an automated and technically simple manner.

In accordance with an aspect of the invention, the machine learning system may further be trained to classify the components that were classified as “non-serviceable” into either a “repairable” category or a “non-repairable” category. This enables leaner work processes because scrap can be quickly sorted out in the event that the machine learning system can make an unambiguous classification.

In accordance with a preferred embodiment, the machine learning system may additionally be trained to assign a probability of successful repair to the components classified as “repairable.” For this purpose, it is possible to use feedback about repairs actually performed on components of the same type; i.e., the input as to whether a repair was successful is fed back into the meta-database of the machine learning system and combined with the inspection data; i.e., the image from the image-capturing device and the other metadata. With a sufficiently large pool of data, a link can thus be established between the type, number, and size of the defects found and the statistical probability of successful repair for a specific component type or even across components. In another preferred embodiment, if the probability of successful repair is lower than, for example, 60%, preferably lower than 40%, an inspected component may be assessed as scrap by the machine learning system. This helps to avoid uneconomical repair attempts and to use MRO resources more efficiently.

In accordance with a further aspect of the invention, the machine learning system may include a neural network, a deep neural network (DNN), a convolutional neural network (CNN), and/or a support vector machine.

In accordance with another aspect of the invention, the machine learning system may be configured to identify and/or locate defects, in particular cracks or pores, contaminants, bonding defects, in the at least one image. The identified defects, in particular a type, number, position and/or size of the identified defects, may be taken into account in the classification of the component. For example, it is possible to identify particularly critical locations of cracks where component failure is particularly likely to occur. This corresponds rather to a symbolic machine learning approach; i.e., as a “starting aid,” the solution approach is based on the procedure used by a human evaluator/inspector who, in a first step, manually identifies and assesses defects in the image.

In accordance with a preferred embodiment, the metadata may be taken into account in the image analysis. In this context, “metadata” means in particular data relating to the operational history of the component. In particular, account may be taken of: cycles (life cycles as specified by the manufacturer or by the approving authority) and/or data of the operator of the components (e.g., derated, not derated) and/or geographical data (where did the aircraft fly with the components) and/or environmental data (what are the conditions under which the component was operated).

In a further embodiment of the invention, the machine learning system may be configured to apply, as a first classification step, a filter to the image received from the image-capturing device. This is another step toward a symbolic approach to more quickly arrive at a convergent solution. Some defects become clearer to the human inspector/evaluator when changing the grayscale gradients, for example. In general, the machine learning system initially looks at the entire, unfiltered data set of the image from the image-capturing device. If, during training, the machine learning system receives the manual marking of the defect in the image together with the filter setting selected by the inspector/evaluator at which he or she detected the defect, the machine learning system may also filter the data to simplify pattern recognition and possibly converge the data faster into a solution. Preferably, the machine learning system may be trained to automatically define regions of interest/regions with a high probability of occurrence of damage phenomena.

In accordance with another aspect of the invention, the machine learning system may be configured to autonomously control the image-capturing device, after analysis of the at least one image, to capture at least one further image of the component with a varied imaging parameter, in particular a varied imaging angle, if a classification criterion cannot be satisfied based on the at least one initial image.

The present invention also provides a method according to the invention for training a machine learning system configured and provided to inspect a component, in particular a component of a turbomachine. In a first step, a machine learning system is provided which includes, in particular, a neural network. An image of the component and metadata about the component are input to the machine learning system, the metadata including, in particular, a component type, a running time of the component, a number of remaining life cycles and/or a repair history.

In a further step, the machine learning system classifies the component into a “serviceable” category or a “non-serviceable” category based on the input data and subsequently outputs the determined category, for example, on a display screen.

After that, correct information about the category of the component is fed into the machine learning system to train it. This means that the machine learning system first inspects the component based on its current level of training or knowledge and is then further trained with a selected “sample solution.” If this sample solution or correct information matches the assessment of the machine learning system, the procedure can be continued with the next component. If the inspection results do not match, the assessment criteria may be manually or automatically adjusted, for example, using reinforcement learning techniques.

In accordance with a preferred embodiment, the above-mentioned correct information used to train the machine learning system may be generated based on a human inspection of the component.

In accordance with a further aspect of the invention, the machine learning system may be trained to provide a lifespan prediction for the components classified as “serviceable.”

In accordance with another preferred aspect of the invention, analogously to the aforedescribed inspection methods, the machine learning system may additionally perform, during the classification step, a classification into a “repairable” category or a “non-repairable” category, a determination of a probability of successful repair, and/or an identification of defects in the at least one image of the component, and accordingly, a correct category or correctly identified defects may be input into the machine learning system during inputting of the correct information for training purposes.

In accordance with a preferred embodiment, metadata may be used in the training of the self-learning algorithm. In this context, “metadata” means in particular data relating to the operational history of the component. In particular, account may be taken of: cycles (life cycles as specified by the manufacturer or by the approving authority) and/or data of the operator of the components (e.g., derated, not derated) and/or geographical data (where did the aircraft fly with the components) and/or environmental data (what are the conditions under which the component was operated).

The present invention also provides a computer program product, including instructions which are readable by a processor of a computer and which, when executed by the processor, cause the processor to execute the method discussed above.

The present invention also provides a computer-readable storage medium, on which the computer program product according to the preceding aspect is stored.

The present invention also provides a system for inspecting a component, in particular a component of a turbomachine. Such a system has at least one image-capturing device for capturing an X-ray or CT image of the component and a trained machine learning system that is configured to acquire/receive the image from the image-capturing device and metadata about the component and which is trained to classify the component into a “serviceable” category or a “non-serviceable” category based on this data. Furthermore, the system may be trained and configured to perform one or more of the aforedescribed aspects of an inspection method or training method.

### BRIEF DESCRIPTION OF THE DRAWINGS

The invention will now be described in more detail with reference to an exemplary embodiment. The individual features may also be essential to the invention in other combinations within the scope of the other independent claims, and, as above, no distinction is specifically made between different claim categories.

In the drawings,

FIG. 1 shows a schematic view of a turbomachine;

FIG. 2 shows a schematic flow diagram of a method for inspecting a component according to an exemplary embodiment of the present invention;

FIG. 3 shows a schematic flow diagram of a training process for a machine learning system according to an exemplary embodiment of the invention;

FIG. 4 shows a system according to an exemplary embodiment of the invention.

### DETAILED DESCRIPTION OF THE DRAWINGS

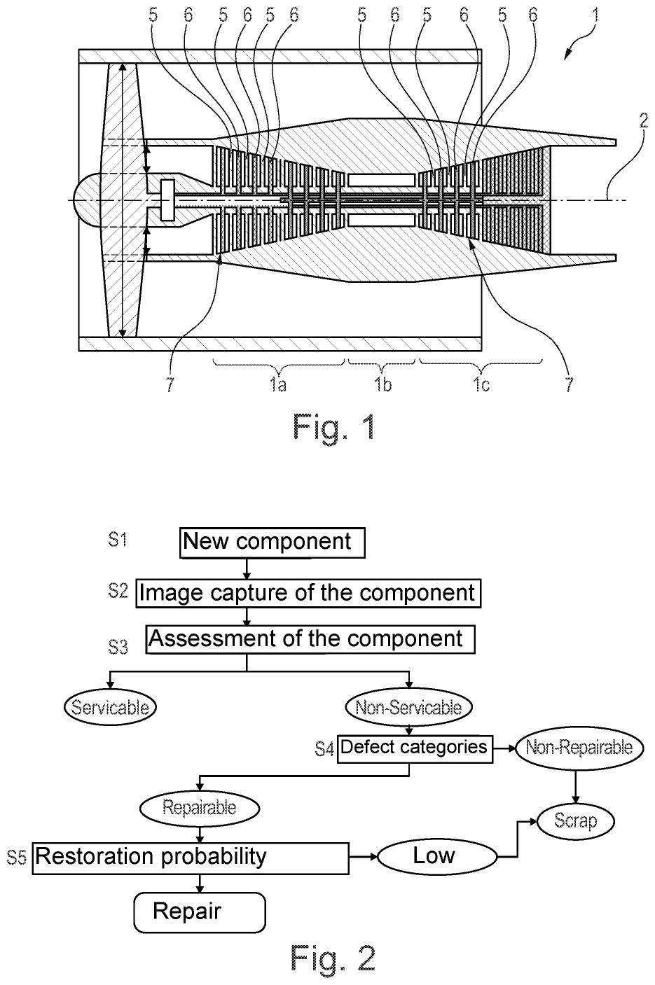

FIG. 1 shows, in axial section, a turbomachine 1, specifically a turbofan engine. Turbomachine 1 is functionally divided into a compressor 1a, a combustor 1b, and a turbine 1c. Both compressor 1a and turbine 1c are made up of a plurality of stages. Each of the stages is composed of a stator 5 and a rotor 6. Reference numeral 7 indicates the gas flow path; i.e., the compressor gas path in the case of compressor 1a and the hot gas path in the case of turbine 1c. The intake air is compressed in the compressor gas path and is then mixed and burned with jet fuel in the downstream combustor 1b. The hot gas flows through the hot gas path, thereby driving rotors 6, which rotate about axis of rotation 2.

FIG. 2 illustrates, in a schematic diagram, a method for inspecting a component 10, in particular a component 10 of a turbomachine, preferably a component 10 of an engine, according to an embodiment of the present invention. In a first step (S1), a component to be inspected arrives at an inspection station 100 (see FIG. 4). In a next step (S2), the component is placed into an image-capturing device 20, and at least one image is captured. In the example described here, an X-ray or CT image of the component is captured at a predetermined angle. Also conceivable are embodiments having, for example, a photo box that captures light images under constant conditions. The predetermined angle may, for example, be selected to obtain a sectional view of the component which brings out component regions that are particularly often damaged during operation.

In subsequent step (S3), the at least one image captured by image-capturing device 20 is provided to a machine learning system 30 having a computer or processing device on which at least one database and a trained self-learning algorithm are stored. Machine learning system 30 first determines whether or not the image of the component, or component 10, shows at least one defect, such as a crack or at least one pore. In addition, machine learning system 30 may output or generate an image in which the detected or identified defects, in particular cracks and/or pores, are marked in the image of component 10. These markings may, for example, by include colored elements corresponding to the shape of the defect, crack, or pore, labels, or the like and may serve as a guide for the inspector/evaluator in marking defects on the real component. If machine learning system 30 has not detected a defect; i.e., a crack or pore, in the complete image, component 10 may be marked as defect-free.

In the exemplary embodiment described, the algorithm is trained to classify component 10 into either a “serviceable” category or a “non-serviceable” category. In this context, “serviceable” means that the component could be put into service in compliance with regulations. This means that either the component was found to be free of defects or the defects determined by machine learning system 30 are so minor that no impact on component 10 is to be expected during operation, even when taking a high safety factor into account. In order to perform the classification, the trained self-learning algorithm uses metadata about component 10 stored in the database, the metadata including, inter alia, the running time, the remaining life cycles (prior to repair), the operator (e.g., airline company), nominal or measured wall thicknesses, a repair history, or a history of the environment in which the component was operated.

Step (S4) is only performed if component 10 was classified as “non-serviceable” in step (S3). In this case, the machine learning system performs another classification of the component: into either a “repairable” category or a “non-repairable” category. If the component should be classified into the “repairable” category, the machine learning system predicts, in a step S5, the probability of a successful repair. To make this prediction, machine learning system 30 may access a database in which are stored previous inspection procedures/results for components of the same type (captured images, metadata, and inspection result) as well as the final results of the repairs of these components. In other words, image and metadata generated in the past for components of the same type, the predictions made based on this data, as well as the ultimate success or failure of the repair are combined in the database to serve as a basis for a prediction of a component being inspected. By way of example, if a crack of a certain length was detected on a component being inspected, it would be possible to check, in the database, how high the probability of successful repair of the same type of component with a crack of comparable length (e.g., +/−10%) was in the past.

Upon completion of step S5, component 10 is passed on to the next station for the first repair step, along with the generated prediction of the restoration probability and the determined defect positions and types and levels of progression.

For the purposes of the aforedescribed classification and the estimation of the probability of successful repair, in particular the length of the defect or defects, in particular of the crack or cracks or of the pore or pores, the width of the defect or defects, in particular of the crack or cracks, the size or diameter of the defect or pore, and/or the number of defects, in particular cracks and/or pores, may be used as classification characteristics.

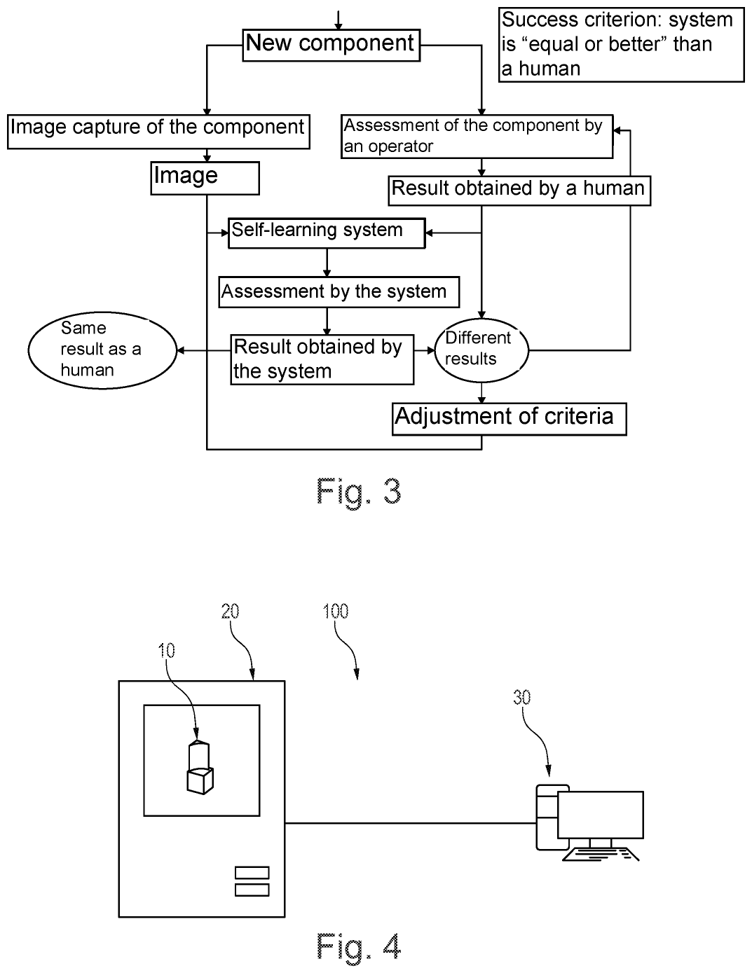

FIG. 3 discloses the earlier-mentioned machine learning system 30 (see FIG. 4) and its a self-learning algorithm. This may be, in particular, a support vector machine (SVM), a neural network, a deep neural network (DNN), a convolutional neural network (CNN), or the like. As illustrated in FIG. 3, this is trained as follows to inspect components:

As a starting point for the training of machine learning system 30, it is conceivable that images which have been correctly marked by a human as “showing” defects, in particular cracks and/or pores (also referred to as “including an indication”) or as “not showing” defects, in particular cracks and/or pores (also referred to as “not including an indication”) may be input into machine learning system 30 as “truth.” It is also conceivable that, in addition, the image in which a human has correctly marked the locations or positions of the defects, in particular cracks and/or pores, may be input as “truth” into machine learning system 30. These images are input into machine learning system 30 in the context with the metadata mentioned earlier (running time, LLP, etc.). In summary, a data set pre-assessed by a human may serve as a starting point for the training of machine learning system 30.

Machine learning system 30 may then be further trained, as it were “in situ,” sharpening its defect detection capability. To this end, a picture or an image of component 10 captured by image-capturing device 20 is input into machine-learning system 30. During image capture, component 10 was X-rayed, producing a grayscale representation where even defects or irregularities underneath the surface of component 10 are contained in the signal. Based on the image captured by image-capturing device 20, the metadata about component 10 stored in the database, and the learning history, machine learning system 30 outputs information on whether or not component 10 has defects, in particular cracks or pores, and outputs an image in which the defects, in particular cracks or pores, detected by it are marked. In addition, based on the above-mentioned data, machine learning system 30 classifies component 10 as serviceable/non-serviceable and as repairable/non-repairable according to the procedure described in FIG. 2.

A trainer (e.g., a human evaluator) examines the captured image of the component (and possibly also the physical component itself), either in parallel or subsequently, and corrects the information or provides correct information on whether or not component 10 has defects, in particular cracks or pores. This is input into machine learning system 30 so that machine learning system 30 can learn. In this context, for example, the human evaluator/trainer may also manually mark, for example, a crack, to train the algorithm. In addition, the trainer indicates his or her classification of component 10 into the categories serviceable/non-serviceable and repairable/non-repairable as a reference.

Machine learning system 30 automatically recognizes the differences between the image captured by it, in which the defects, in particular cracks and/or pores, detected by machine learning system 30 are marked, and the image in which the defects, in particular cracks and/or pores, correctly detected by a human are marked. The machine learning system also automatically recognizes deviations of its classification of the component from the human classification. If machine learning system 30 did not detect a defect or if it marked a defect-free region incorrectly as a defect, it learns from the human findings and may re-weight its assessment criteria.

If the machine classification and defect detection matches the classification and defect detection by the trainer, machine learning system 30 is further trained on the next component. If there is a deviation, the trainer compares the results and may manually adjust the criteria. Alternatively, the machine learning system may automatically adjust its assessment criteria based on the human assessment. The image is then reassessed by machine learning system 30 using the adjusted criteria. This is repeated until the machine assessment matches the human assessment.

This training of machine learning system 30 may be repeated with a multiplicity of images, preferably of different components 10 of the same type.

Machine learning system 30 may be trained by different persons. This means that different people identify defects, in particular cracks and/or pores, in the complete image and input this information into machine learning system 30.

Once machine learning system 30 has been trained to the point where it performs defect search and component classification as well as a human (qualified and trained for this task), the training may possibly be terminated, and the human only has to monitor and control the operation of system 100 with machine learning system 30.

Component 10 may be, for example, a component of an engine. For example, component 10 may be a rotor or a blade of a high-pressure compressor (HPC) or a rotor or a blade of a high-pressure turbine (HPT) of an engine. The engine may in particular be an engine of an aircraft.

### LIST OF REFERENCE NUMERALS

1 turbomachine
1a compressor
1b combustor
1c turbine
2 axis of rotation
5 rotor
6 stator
7 gas flow path
10 component
20 image-capturing device
30 machine learning system
100 inspection station

What is claimed is:

1-13. (canceled)

14. A method for inspecting a component comprising the steps of:
capturing at least one image of the component using an image-capturing device;
providing metadata about the component; and
classifying, by a trained machine learning system, the component into a “serviceable” category or a “non-serviceable” category based on the image captured by the image-capturing device and the provided metadata.

15. The method as recited in claim 14 wherein the image is a light image, an X-ray or CT image, and the metadata includes a component type, a running time of the component, a number of remaining life cycles, or a repair history.

16. The method as recited in claim 14 wherein the machine learning system classifies the components classified as “non-serviceable” into either a “repairable” category or a “non-repairable” category.

17. The method as recited in claim 16 wherein the machine learning system assigns a probability of successful repair to the components classified as “repairable.”

18. The method as recited in claim 14 wherein the machine learning system includes a neural network or a support vector machine.

19. The method as recited in claim 18 wherein the neural network is a deep neural network, a convolutional neural network

20. The method as recited in claim 14 wherein the machine learning system is configured to identify or locate defects in the at least one image, and to take the identified or located defects into account in the classification of the component.

21. The method as recited in claim 20 wherein the defects are cracks or pores and a type, position, number or size of the identified defects is taken into account in the classification.

22. The method as recited in claim 14 wherein the metadata used includes at least remaining life cycles of the component or data of the operator of the components or geographical data or environmental data.

23. The method as recited in claim 14 wherein the machine learning system is configured to autonomously control the image-capturing device, after analysis of the at least one image, to capture at least one further image of the component with a varied imaging parameter if a classification criterion cannot be satisfied based on the at least one initial image.

24. The method as recited in claim 23 wherein the varied imaging parameter is a varied imaging angle.

25. The method as recited in claim 14 wherein the component is of a turbomachine.

26. A method for training a machine learning system to inspect a component, the method comprising the following steps:
providing a machine learning system;
inputting an image of the component into the machine learning system;
inputting metadata about the component into the machine learning system, the metadata including at least a component type or a running time of the component or a number of remaining life cycles or a repair history or data of the operator of the components or geographical data or environmental data;
classifying the component into a “serviceable” category or a “non-serviceable” category based on the input data;
outputting the determined category; and
inputting correct information about the category of the component into the machine learning system to train the machine learning system.

27. The method as recited in claim 26 wherein the component is of a turbomachine.

28. The method as recited in claim 26 wherein the machine learning system includes a neural network

29. The method as recited in claim 26 wherein the correct information is generated based on a human inspection of the component.

30. The method as recited in claim 26 wherein the machine learning system additionally performs, during the classification step, a classification into a “repairable” category or a “non-repairable” category, a determination of a probability of successful repair, or an identification of defects in the at least one image of the component, and accordingly, a correct category or correctly identified defects is input into the machine learning system during inputting of the correct information for training purposes.

31. A computer program product comprising instructions which are readable by a processor of a computer and which, when executed by the processor, cause the processor to execute the method as recited in claim 26.

32. A computer-readable medium on which the computer program product according to claim 24 is stored.

33. A system for inspecting a component, the system comprising:
an image-capturing device for capturing an image of the component; and
a trained machine learning system configured to receive the image from the image-capturing device and metadata about the component and trained to classify the component into a “serviceable” category or a “non-serviceable” category based on this data.
